(19) United States
(12) Patent Application Publication
(10) Pub. No.: US 2005/0084362 A1
(43) Pub. Date: Apr. 21, 2005

(54) Insert-nut of a carrier in a car

(75) Inventor: Il Nah, Yongin-shi (KR)

Correspondence Address: GREENBLUM & BERNSTEIN, P.L.C., 1950 ROLAND CLARKE PLACE, RESTON, VA, 20191, US

(73) Assignee: HYUNDAI MOBIS Co., Ltd., Seoul (KR)

(21) Appl. No.: 10/720,337

(22) Filed: Nov. 25, 2003

(30) Foreign Application Priority Data
Oct. 17, 2003 (KR) 2003-72660

(51) Int. Cl. F16B 37/04

(52) U.S. Cl. 411/180

(57) ABSTRACT

An insert-nut of a carrier in a car which is formed in a hexagonal shape and has at least one groove formed in a longitudinal direction at regular intervals is disclosed. The insert-nut is engaged with a plastic part of the carrier in the car, at least one groove is formed in longitudinal direction at regular intervals, and the insert-nut is formed in a polygonal shape. In accordance with the present invention, plastic can be easily injected to increase joint strength and improve rotational resistance.

### RELATED APPLICATION

The present disclosure relates to subject matter contained in Korean application No.2003-72660, filed on Oct. 17, 2003, which is herein expressly incorporated by reference its entirety.

### BACKGROUND OF THE INVENTION

1. Field of the Invention

The present invention relates to an insert-nut of a carrier in a car, and more particularly, to an insert-nut of a carrier in a car capable of enduring rotational torque, and improving joint strength by being formed so as to be easily inject plastic.

2. Description of the Related Art

Generally, a chassis of an automobile forms the profile of the automobile to divide the interior of the automobile, engine space, trunk or fender, etc.; the chassis is classified into a front chassis, a center chassis and a rear chassis lengthwise in the automobile.

A carrier is mounted in front of the front chassis, the carrier is provided with an integrated assembly including a headlamp, a radiator, a condenser, a bumper and a chassis panel to improve assembly performance in the field, the number of parts for assembly is decreased to reduce an assembly time, and the technology ensuring performance of products, i.e., a front end module (FEM) is adopted.

At this time, the carrier is adopted as a hybrid structure formed by integrally injecting both steel and plastic.

FIG. 1 is a view illustrating a prior art carrier, and FIG. 2 is a view for illustrating a prior art insert-nut.

As shown in FIG. 1, a carrier 10 is provided with a headlamp mounting part 11 formed on both its upper sides, and a cooling module mounting part 12 for mounting a cooling module such as a radiator and a condenser in the front.

Further, the carrier includes a bracket 14 connected from a middle part to the lower part of an upper frame 13 of the cooling module mounting part 12 to mount a horn speaker, etc., and a lower frame 15 formed at a lower part of the cooling module mounting part 12 to mount a bumper or fog light.

At this time, the carrier 10 is provided with a nut and a bolt for mounting the above-mentioned devices; since the carrier 10 is made of steel and plastic, different kinds of fixing members should be used.

Formed at a steel part of the carrier 10 is a weld-nut or a weld-bolt, and formed at the plastic part is a nutsert or an insert-nut 20, thereby attaching the above devices.

As shown in FIG. 2, the insert-nut 20 is formed in a circular shape in appearance, protrusions 22 are formed along its outer periphery at regular intervals, and grooves 24 are formed in a longitudinal direction at regular intervals.

The insert-nut 20 forms an insert-hole at a predetermined position of the plastic part of the carrier 10, and the insert-nut 20 is inserted into the insert-hole, and then, the plastic part of the carrier 10 is injected to combine them.

However, an inlet port, at which plastic is to be injected between the protrusions 22 formed at the outer periphery surface of the insert-nut 20, is too small to easily inject the plastic, thereby generating a gap therebetween.

As described, when a gap is generated between the insert-hole of the carrier 10 and the insert-nut 20, there are problems of lower joint strength, and reducing the rotational resistance power due to a lowering of the joint strength.

### SUMMARY OF THE INVENTION

To solve the above-mentioned problems, an object of the present invention is to provide an insert-nut of a carrier in a car capable of easily injecting plastic and increasing joint strength by forming the profile in a polygonal shape and forming grooves in a longitudinal direction at regular intervals.

To accomplish the above-mentioned objects, the present invention provides an insert-nut engaged with a plastic part of an automobile carrier, forming at least one groove along its longitudinal direction at regular intervals and having a polygonal shape.

Preferably, the insert-nut has a hexagonal shape.

In accordance with the above constitution, plastic is easily injected around the insert-nut to increase joint strength with the carrier, thereby improving a rotational resistance power.

### BRIEF DESCRIPTION OF DRAWINGS

These and other features, aspects, and advantages of preferred embodiments of the present invention will be more fully described in the following detailed description, taken accompanying drawings. In the drawings:

FIG. 1 is a view for illustrating a prior art carrier;

FIG. 2 is a view for illustrating a prior art insert-nut;

FIG. 3 is a view for illustrating an embodiment of an insert-nut of a carrier in a car;

FIG. 4 is a front view for an insert-nut inserted into a carrier in a car in accordance with the present invention; and

FIG. 5 is a view for illustrating another embodiment of an insert-nut of carrier in a car in accordance with the present invention.

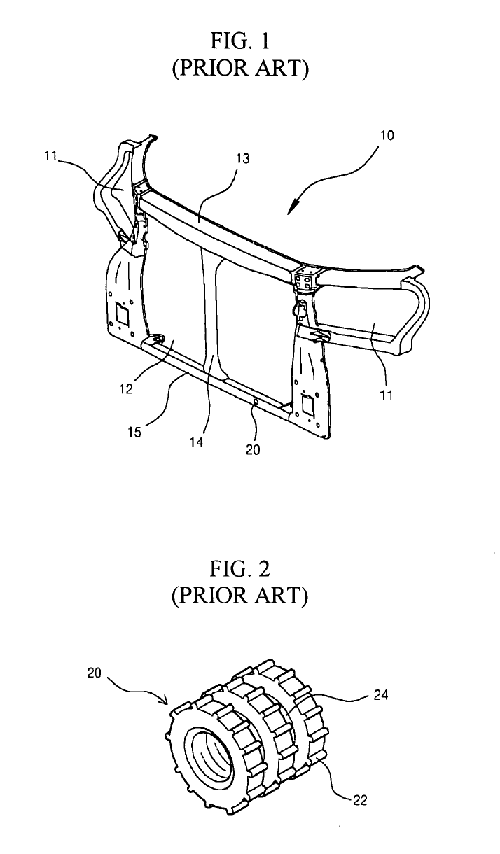

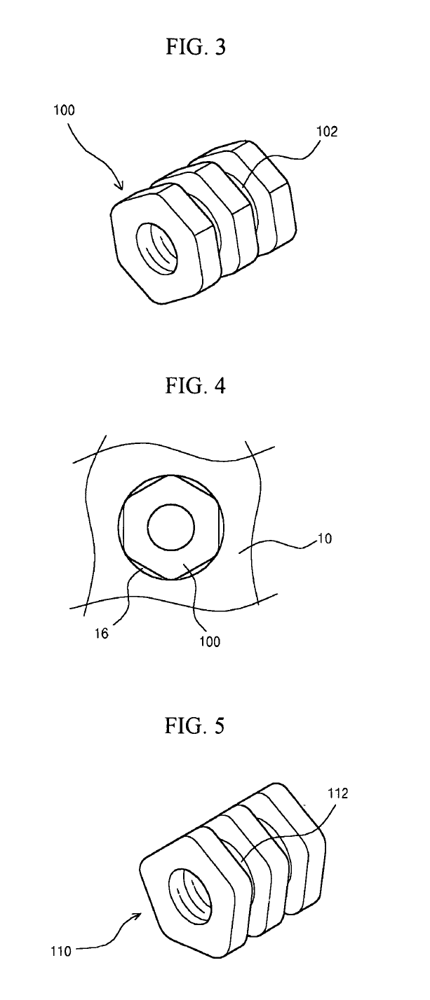

### DESCRIPTION OF THE PREFERRED EMBODIMENT

Hereinafter, the present invention will be apparent from the detailed description in conjunction with the accompanying drawings.

In addition, the present embodiment is not limited to the appended claims, but is intended to include various modifications within the spirit and scope of the present invention.

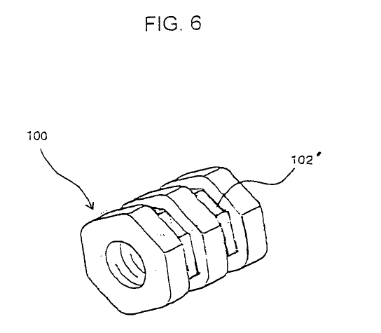

FIG. 3 is a view for illustrating an embodiment of an insert-nut of a carrier in a car; FIG. 4 is a front view for an insert-nut inserted into a carrier in a car in accordance with the present invention; and FIG. 5 is a view for illustrating-another embodiment of an insert-nut of carrier in a car in accordance with the present invention.

As shown in the drawings, the carrier 10 is assembled to a front chassis of a car, and mounted on the carrier 10 are a headlamp, a cooling module, a horn speaker, a bumper and a fog light.

A mounting part is formed at a predetermined position of the carrier 10 to mount the above devices, and the insert-nut 100 is injected into the plastic part of the carrier 10.

That is, an installation hole 16 is formed at a predetermined position of the plastic part of the carrier 10, the insert-nut 100 is inserted into the installation hole 16, and then, plastic is inserted into an inlet port between the installation hole 16 and the insert-nut 100 to combine them.

At this time, the insert-nut 100 has a polygonal shape, preferably, a hexagonal shape.

When the insert-nut 100 is formed in a hexagonal shape the size of the inlet port is larger as compared to when a prior art insert-nut 20 is inserted, thus making injection of the plastic easy.

In addition, a length of the insert-nut 100 is formed to correspond to the thickness of the plastic part of the carrier 10, and a groove 102 is formed in longitudinal direction of the insert-nut 100, preferably, at least one groove is formed.

As shown in FIG. 5, the insert-nut 110 is formed in a pentagon shape, and grooves 112 are formed in longitudinal direction at regular intervals to make an inlet port between the installation hole 16 formed in the carrier 10 and the insert-nut 110 larger, thereby easily injecting plastic to the inlet port.

Hereinafter, operations and effects of the present invention will be described in conjunction with the accompanying drawings.

First, the installation hole 16 is formed at positions where a headlamp, a cooling module, a horn speaker, a bumper and fog light, are mounted on the carrier 10, and then, the insert nut 100 is inserted into the installation hole 16.

At this time, the insert-nut 100 is formed in a polygonal shape to thereby generate the inlet port between the installation hole 16 and the insert-nut 100.

Since the inlet port should have a size larger than a predetermined size to make injection easy, the insert-nut 100 is formed in a polygonal shape, preferably, a hexagonal shape having a good rotational resistance.

As described hereinabove, the insert-nut 100 of the hexagonal shape is inserted into the installation hole 16 to engage it by injecting plastic; when the plastic is injected, it is melted to be injected to the inlet port between the insert-nut 100 and the installation hole 16.

At this time, a size of the inlet port between the insert-nut 100 and the installation hole 16 is larger as compared to when a prior art insert-nut 20 is used, thus making injection of the plastic easy.

Further, the plastic injected into the inlet port is introduced in a longitudinal direction of the insert-nut 100 to flow into the at least one groove 102 formed at the insert-nut 100, and then, the plastic hardens to engage the insert-nut 100 with the carrier 10.

At this time, the groove 102 is formed in order to improve rotational resistance by combining the insert-nut 100 with the carrier-10 much better, and the reason why the insert-nut 100 is formed in a hexagonal shape is to make it easy to inject plastic to the groove 102.

That is, the insert-nut 100 is formed in a hexagonal shape to secure the inlet port for easily injecting plastic to be put into the groove 102, thereby increasing joint strength.

For reference, the groove 102 is basically formed in a circular shape; it may be formed in a polygonal shape to increase joint strength and the rotational resistance.

As shown in FIG. 5, the insert-nut 100 is formed in a pentagon shape, and at least one groove 102 is formed in a longitudinal direction at regular intervals.

As described hereinabove, when the insert-nut 100 is formed in a pentagon shape, the inlet port between the installation hole 16 of the carrier 10 and the insert-nut 100 becomes much bigger to make it easy to inject the plastic.

As described hereinabove, the present invention provides an insert-nut of a carrier in a car capable of preventing a gap from forming between the carrier and the insert-nut, improving joint strength by preventing the gap from forming and improving rotational resistance, by forming the inlet port having such a size to easily inject plastic upon the injection of the carrier and the insert-nut.

While this invention has been described in connection with what is presently considered to be the most practical and preferred embodiment, it is to be understood that the invention is not limited to the disclosed embodiment, but is intended to cover various modifications within the spirit and scope of the appended claims.

1. An insert-nut for use with a carrier of a car, the insert-nut having a polygonal shape defined by a plurality of sidewalls and at least one circumferentially extending groove that is provided along a longitudinal dimension of the insert-nut, the plurality of sidewalls of the insert-nut being configured to provide a plurality of gaps between the sidewalls of the insert-nut and a surface of an installation hole of the carrier, whereby plastic is injectable into the plurality of gaps and into the at least one groove to secure the insert-nut to the carrier.

2. The insert-nut according to claim 1, wherein the polygonal shape comprises a hexagon.

3. The insert-nut according to claim 1, wherein the polygonal shape comprises a pentagon.

4. The insert-nut according to claim 1, wherein the longitudinal dimension of the insert-nut corresponds to a thickness of the carrier.

5. The insert-nut according to claim 1, wherein a shape of the at least one groove is circular.

6. The insert-nut according to claim 1, wherein a shape of the at least one groove is polygonal.

7. The insert-nut according to claim 1, wherein the at least one groove comprises a plurality of grooves spaced along the longitudinal dimension of the insert-nut.

8. A method for securing an insert-nut within an insert hole, said method comprising:
mounting the insert-nut into the insert hole, wherein the insert-nut comprises a polygonal shape with at least one circumferentially extending groove provided along a longitudinal dimension of the insert-nut, a plurality of gaps being provided between the insert-nut and a surface of the insert hole; and
injecting plastic into the plurality of gaps and into the at least one groove of the insert-nut.

9. The method according to claim 8, wherein the polygonal shape comprises a pentagon.

10. The method according to claim 8, wherein the polygonal shape comprises a hexagon.

11. The method according to claim 8, further comprising forming a longitudinal dimension of the insert-nut to correspond to a thickness of a carrier within which the insert-hole is defined.

12. The method according to claim 8, wherein a shape of the at least one groove is circular.

13. The method according to claim 8, wherein a shape of the at least one groove is polygonal.

14. The method according to claim 8, wherein the at least one groove comprises a plurality of grooves spaced along the longitudinal dimension of the insert-nut.
